(19) United States
(12) Patent Application Publication
(10) Pub. No.: US 2017/0368758 A1
(43) Pub. Date: Dec. 28, 2017

(54) THREE-DIMENSIONAL SHAPING APPARATUS, METHOD OF CONTROLLING SAME, AND SHAPED OBJECT OF SAME

(71) Applicant: Mutoh Industries Ltd., Tokyo (JP)

(72) Inventor: Takashi Touma, Tokyo (JP)

(21) Appl. No.: 15/543,777

(22) PCT Filed: Sep. 29, 2015
(86) PCT No.: PCT/JP2015/077554

§ 371 Date: Jul. 14, 2017

(30) Foreign Application Priority Data
Jan. 15, 2015 (JP) 2015-005895

(51) Int. Cl. B29C 64/393; B33Y 30/00; B33Y 50/02; B32B 27/08; B33Y 10/00; B29C 64/232; B29C 64/236; B29C 64/118; B29L 9/00; B29L 31/34

(52) U.S. Cl. CPC B29C 64/393; B29C 64/236; B33Y 30/00; B33Y 50/02; B29C 64/118; B32B 27/08; B33Y 10/00; B29C 64/232; B29L 2031/3425; B29L 2009/00; B32B 2307/546; B32B 2457/08

(57) ABSTRACT

A control section of this three-dimensional shaping apparatus controls a shaping head such that, in a first layer, first resin materials are continuously formed in a first direction and arranged with a gap between the first resin materials in a second direction intersecting the first direction, and resin materials other than the first resin materials are continuously formed in the first direction and arranged in the gap. In a second layer provided above the first layer, the first resin materials are continuously formed in a third direction intersecting the first direction and arranged with a gap between the first resin materials in a fourth direction intersecting the third direction, and the resin materials other than the first resin materials are continuously formed in the third direction and arranged in the gap.

### TECHNICAL FIELD

The present invention relates to a three-dimensional shaping apparatus, a method of controlling the same, and a shaped object of the same.

### BACKGROUND ART

A three-dimensional shaping apparatus that manufactures a shaped object based on three-dimensional design data is known by, for example, Patent Document 1. As systems of this kind of three-dimensional shaping apparatus, various systems, such as an optical shaping method, a powder sintering method, an ink jet method, and a molten resin extrusion shaping method have been proposed and made into products.

As an example, in a three-dimensional shaping apparatus adopting the molten resin extrusion shaping method, a shaping head for discharging a molten resin that is to be a material of a shaped object is mounted on a three-dimensional moving mechanism, and the shaping head is moved in three-dimensional directions to laminate the molten resin while discharging the molten resin, thereby obtaining the shaped object. In addition, a three-dimensional shaping apparatus adopting the ink jet method also has a structure in which a shaping head for dripping a heated thermoplastic material is mounted on a three-dimensional moving mechanism.

In this kind of three-dimensional shaping apparatus, employing a plurality of materials in one shaped object is presented in several documents, for example. However, when generating this kind of shaped object that complexly employs a plurality of materials, there is a problem that joining between the differing plurality of materials is weak, and a possibility of interlayer peeling occurring is high.

### PRIOR ART DOCUMENT

### Patent Document

Patent Document 1: JP 2002-307562 A

### DISCLOSURE OF INVENTION

### Problem to be Solved by the Invention

The present invention has an object of providing a three-dimensional shaping apparatus that, even when generating a shaped object that complexly employs a plurality of materials, can strengthen joining between the differing materials. In addition, the present invention has an object of providing a method of controlling the three-dimensional shaping apparatus and of providing a shaped object of the three-dimensional shaping apparatus.

### Means for Solving the Problem

A three-dimensional shaping apparatus according to the present invention includes: a shaping stage on which a shaped object is placed; an elevator section which is movable in at least a perpendicular direction with respect to the shaping stage; a shaping head which is mounted in the elevator section and receives supply of plural kinds of resin materials whose materials differ; and a control section that controls the elevator section and the shaping head. The control section controls the shaping head such that, in a first layer, first resin materials are continuously formed in a first direction and arranged with a gap between the first resin materials in a second direction intersecting the first direction, and second resin materials other than the first resin materials are continuously formed in the first direction and arranged in the gap the first resin materials being one of the plural kinds of resin materials, and the second resin material being one of the plural kinds of resin materials. The control section further controls the shaping head such that, in a second layer provided above the first layer, the first resin materials are continuously formed in a third direction intersecting the first direction and arranged with a gap between the first resin materials in a fourth direction intersecting the third direction, and the second resin materials are continuously formed in the third direction and arranged in the gap. As a result, the first resin materials formed in the first layer and the first resin materials formed in the second layer are joined in an up-down direction. Furthermore, the second resin materials formed in the first layer and the second resin materials formed in the second layer are joined in the up-down direction.

In addition, a shaped object according to the present invention is a shaped object that includes plural kinds of resin materials, and includes a first layer and a second layer. The first layer includes a portion where first resin materials are continuously formed in a first direction and arranged with a gap between the first resin materials in a second direction intersecting the first direction, and second resin materials other than the first resin materials are continuously formed in the first direction and arranged in the gap the first resin materials being one of the plural kinds of resin materials, and the second resin material being one of the plural kinds of resin materials. Moreover, the second layer provided above the first layer includes a portion where the first resin materials are continuously formed in a third direction intersecting the first direction and arranged with a gap between the first resin materials in a fourth direction intersecting the third direction, and the second resin materials are continuously formed in the third direction and arranged in the gap, the first resin materials being one of the plural kinds of resin materials, and the second resin material being one of the plural kinds of resin materials, whereby the first resin materials formed in the first layer and the first resin materials formed in the second layer are joined in an up-down direction, and, furthermore, the second resin materials formed in the first layer and the second resin materials formed in the second layer are joined in the up-down direction.

Moreover, a method of controlling a three-dimensional shaping apparatus according to the present invention is a method of controlling a three-dimensional shaping apparatus that includes a shaping head. In this method, the shaping head is controlled such that, in a first layer, first resin materials of plural kinds of resin materials are continuously formed in a first direction and arranged with a gap between the first resin materials in a second direction intersecting the first direction, and second resin materials other than the first resin materials are continuously formed in the first direction and arranged in the gap, the first resin materials being one of the plural kinds of resin materials. Next, the shaping head is controlled such that, in a second layer provided above the first layer, the first resin materials are continuously formed in a third direction intersecting the first direction and arranged with a gap between the first resin materials in a fourth direction intersecting the third direction, and the second resin materials are continuously formed in the third direction and arranged in the gap. As a result, the first resin materials formed in the first layer and the first resin materials formed in the second layer are joined in an up-down direction, and, furthermore, the second resin materials formed in the first layer and the second resin materials formed in the second layer are joined in the up-down direction.

### BRIEF DESCRIPTION OF DRAWINGS

FIG. 1 is a perspective view showing a schematic configuration of a three-dimensional shaping apparatus according to a first embodiment.

FIG. 2 is a front view showing a schematic configuration of the three-dimensional shaping apparatus according to the first embodiment.

FIG. 3 is a perspective view showing a configuration of an XY stage 12.

FIG. 4 is a plan view showing a configuration of an elevator table 14.

FIG. 5 is a functional block diagram showing a configuration of a computer 200 (control device).

FIG. 6 is a side view showing an example of a structure of a shaped object S formed by the present embodiment.

FIG. 7 is a perspective view showing an example of a structure of the shaped object S formed by the present embodiment.

FIG. 8 is a process drawing showing manufacturing steps of the shaped object S shown in FIGS. 6 and 7.

FIG. 9 is a side view showing another example of a structure of the shaped object S formed by the present embodiment.

FIG. 10 is a perspective view showing another example of a structure of the shaped object S formed by the present embodiment.

FIG. 11 is a side view showing another example of a structure of the shaped object S formed by the present embodiment.

FIG. 12 is a perspective view showing another example of a structure of the shaped object S formed by the present embodiment.

FIG. 13 is a side view showing another example of a structure of the shaped object S formed by the present embodiment.

FIG. 14 is a side view showing another example of a structure of the shaped object S formed by the present embodiment.

FIG. 15 is a plan view showing an example of a structure of the shaped object S formed by the present embodiment.

FIG. 16 is a plan view showing an example of a structure of the shaped object S formed by the present embodiment.

FIG. 17 shows a modified example of the shaped object S.

FIG. 18 shows a modified example of the shaped object S.

FIG. 19 shows a modified example of the shaped object S.

FIG. 20 is a flowchart showing a procedure of shaping by the three-dimensional shaping apparatus of the present embodiment.

FIG. 21 is a schematic view showing a procedure of shaping by the three-dimensional shaping apparatus of the present embodiment.

FIG. 22 shows a schematic configuration of a three-dimensional shaping apparatus according to a second embodiment.

FIG. 23 is a perspective view showing a schematic configuration of a three-dimensional shaping apparatus according to a modified example.

FIG. 24A is a process drawing explaining another method for manufacturing the shaped object S.

FIG. 24B is a process drawing explaining another method for manufacturing the shaped object S.

FIG. 24C is a process drawing explaining another method for manufacturing the shaped object S.

FIG. 24D is a process drawing explaining another method for manufacturing the shaped object S.

FIG. 25 shows a first specific example of the shaped object S.

FIG. 26 shows a second specific example of the shaped object S.

FIG. 27 shows a third specific example of the shaped object S.

FIG. 28 shows a fourth specific example of the shaped object S.

### BEST MODE FOR CARRYING OUT THE INVENTION

Next, embodiments of the present invention will be described in detail with reference to the drawings.

### First Embodiment

(Overall Configuration)

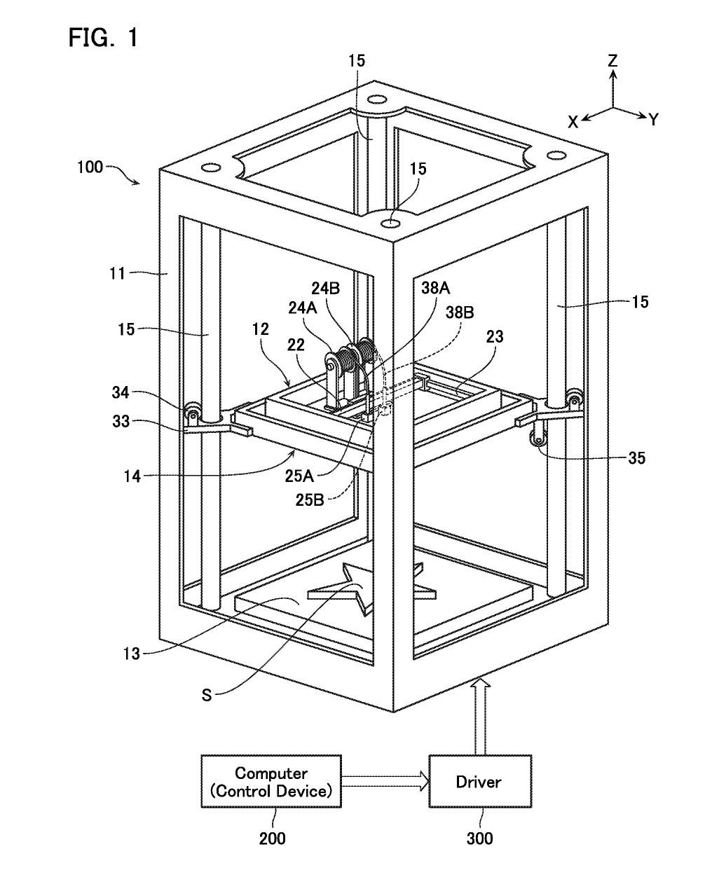

FIG. 1 is a perspective view showing a schematic configuration of a 3D printer 100 employed in a first embodiment. The 3D printer 100 includes a frame 11, an XY stage 12, a shaping stage 13, an elevator table 14, and a guide shaft 15.

A computer 200 acting as a control device that controls this 3D printer 100 is connected to this 3D printer 100. Moreover, a driver 300 for driving a variety of mechanisms in the 3D printer 100 is also connected to this 3D printer 100.

(Frame 11)

As shown in FIG. 1, the frame 11 has a rectangular parallelepiped external form, for example, and includes a framework of a metal material such as aluminum. Four of the guide shafts 15, for example, are formed in four corners of this frame 11, so as to extend in a Z direction of FIG. 1, that is, a direction perpendicular to a plane of the shaping stage 10. The guide shaft 15 is a linear member defining a direction that the elevator table 14 is moved in an up-down direction as will be mentioned later. The number of guide shafts 15 is not limited to four, and is set to a number enabling the elevator table 14 to be stably supported and moved.

(Shaping Stage 13)

The shaping stage 13 is a platform on which a shaped object S is placed, and is a platform where a thermoplastic resin discharged from a later-mentioned shaping head is deposited.

(Raising-and-Lowering Table 14)

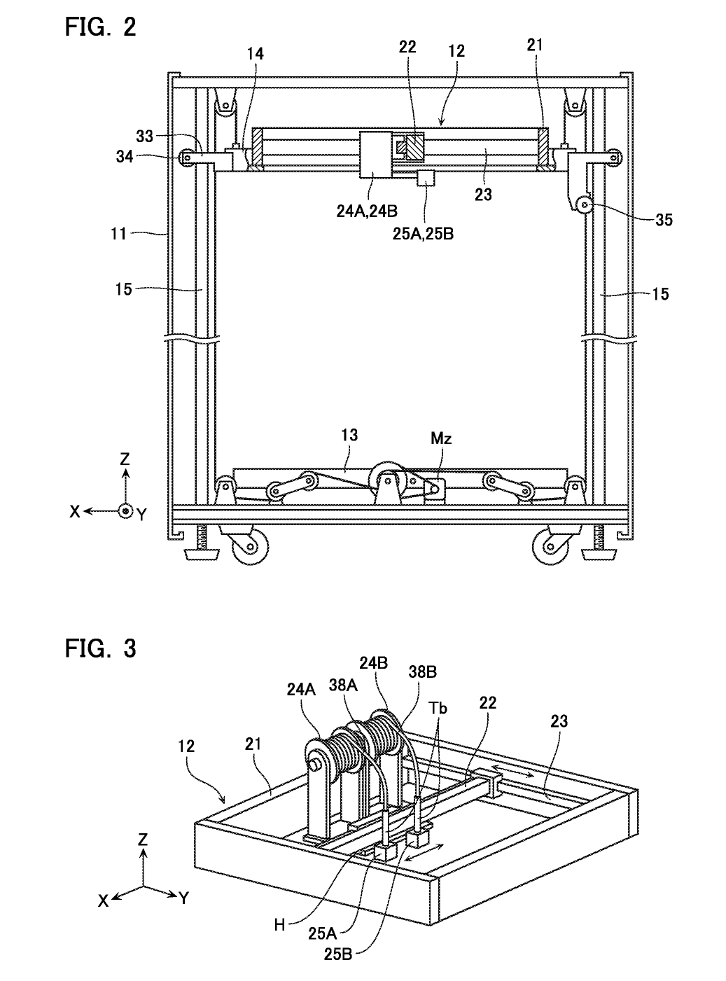

As shown in FIGS. 1 and 2, the elevator table 14 is penetrated at its four corners by the guide shafts 15, and is configured movably along a longitudinal direction (Z direction) of the guide shaft 15. The elevator table 14 includes rollers 34, 35 that contact the guide shafts 15. The rollers 34, 35 are installed rotatably in arm sections 33 formed in two corners of the elevator table 14. These rollers 34, 35 rotate while making contact on the guide shafts 15, whereby the elevator table 14 is enabled to move smoothly in the Z direction. In addition, as shown in FIG. 2, a drive force of a motor Mz is transmitted by a power transmission mechanism configured from the likes of a timing belt, a wire, and a pulley, whereby the elevator table 14 moves in certain intervals (for example, a pitch of 0.1 mm) in the up-down direction. The motor Mz is preferably the likes of a servomotor or a stepping motor, for example. Note that by employing an unillustrated position sensor to measure a position in a height direction of the actual elevator table 14 continuously or intermittently in real time, and making an appropriate correction, it is possible to configure such that positional precision of the elevator table 14 is raised. The same applies also to later-mentioned shaping heads 25A, 25B.

(XY Stage 12)

The XY stage 12 is placed on an upper surface of this elevator table 14. FIG. 3 is a perspective view showing a schematic configuration of this XY stage 12. The XY stage 12 includes a frame body 21, an X guide rail 22, a Y guide rail 23, reels 24A, 24B, the shaping heads 25A, 25B, and a shaping head holder H. The X guide rail 22 has its both ends fitted to the Y guide rail 23, and is held slidably in the Y direction. The reels 24A, 24B are fixed to the shaping head holder H, and move in XY directions following movement of the shaping heads 25A, 25B held by the shaping head holder H. The thermoplastic resin that will be a material of the shaped object S is a string-shaped resin (filaments 38A, 38B) having a diameter of about 3 to 1.75 mm, and is usually held in a wound state in the reels 24A, 24B, but during shaping, is fed into the shaping heads 25A, 25B by a later-mentioned motor (extruder) provided in the shaping heads 25A, 25B.

Note that it is also possible to adopt a configuration in which the reels 24A, 24B are fixed to the likes of the frame body 21 without being fixed to the shaping head holder H, and are not made to follow movement of the shaping heads 25. Moreover, although a configuration has been adopted in which the filaments 38A, 38B are fed in an exposed state into the shaping heads 25, it is possible for the filaments 38A, 38B to be fed into the shaping heads 25A, 25B mediated by a guide (for example, a tube, a ring guide, and so on). Note that, as will be mentioned later, the filaments 38A, 38B are each configured from a different material. As an example, in the case that one is any of an ABS resin, a polypropylene resin, a nylon resin, or a polycarbonate resin, the other can be configured as a resin other than the any one of those resins. Alternatively, it is also possible to configure such that even if the filaments 38A, 38B are of a resin of the same material, kinds or proportions of materials of fillers included on their insides differ. That is, the filaments 38A, 38B preferably each have a different property, and, by their combination, allow characteristics (strength, and so on) of the shaped object to be improved.

Note that in FIGS. 1 to 3, the shaping head 25A is configured so as to melt and discharge the filament 38A, the shaping head 25B is configured so as to melt and discharge the filament 38B, and independent shaping heads are respectively prepared for the different filaments. However, the present invention is not limited to this, and it is possible to adopt also a configuration of the kind where only a single shaping head is prepared, and a plurality of kinds of filaments (resin materials) are selectively melted and discharged by the single shaping head.

The filaments 38A, 38B are fed from the reels 24A, 24B, via tubes Tb, to inside the shaping heads 25A, 25B. The shaping heads 25A, 25B are held by the shaping head holder H, and are configured movably along the X, Y guide rails 22, 23, together with the reels 24A, 25B. Moreover, although illustration thereof is omitted in FIGS. 2 and 3, an extruder motor for feeding the filaments 38A, 38B downwardly in the Z direction is disposed inside the shaping heads 25A, 25B. Although the shaping heads 25A, 25B should be configured capable of moving, along with the shaping head holder H, keeping a constant positional relationship with each other in the XY plane, they may also be configured such that their positional relationship with each other may be changed even in the XY plane.

Note that although illustration thereof is omitted in FIGS. 2 and 3, motors Mx, My for moving the shaping heads 25A, 25B with respect to the XY table 12 are also provided on this XY stage 12. The motors Mx, My are preferably the likes of servomotors or stepping motors, for example.

(Driver 300)

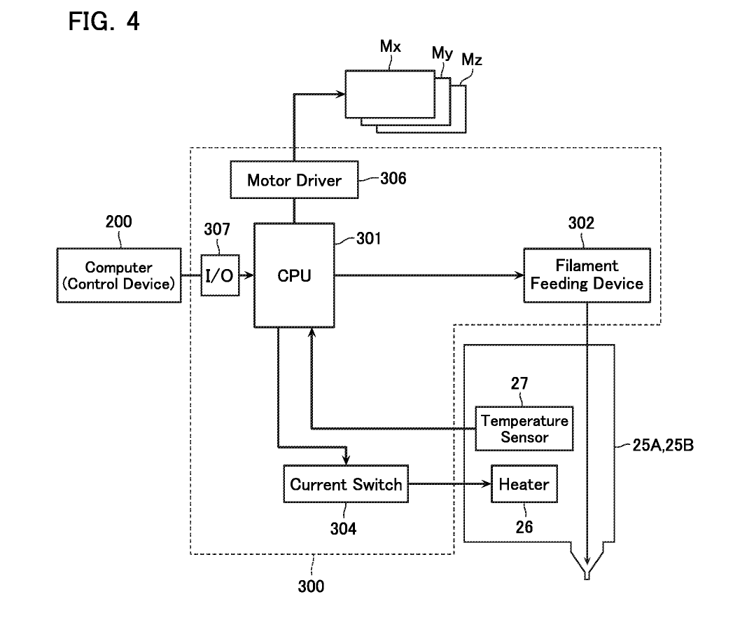

Next, details of a structure of the driver 300 will be described with reference to the block diagram of FIG. 4. The driver 300 includes a CPU 301, a filament feeding device 302, a head control device 303, a current switch 304, and a motor driver 306.

The CPU 301 receives various kinds of signals from the computer 200, via an input/output interface 307, and thereby performs overall control of the driver 300. The filament feeding device 302, based on a control signal from the CPU 301, issues to the extruder motors in the shaping heads 25A, 25B commands controlling a feed amount (push-in amount or saving amount) to the shaping heads 25A, 25B of the filaments 38A, 38B.

The current switch 304 is a switch circuit for switching a current amount flowing in a heater 26. By a switching state of the current switch 304 being switched, a current flowing in the heater 26 increases or decreases, whereby temperature of the shaping heads 25A, 25B is controlled. Moreover, the motor driver 306, based on a control signal from the CPU 301, generates a drive signal for controlling the motors Mx, My, Mz.

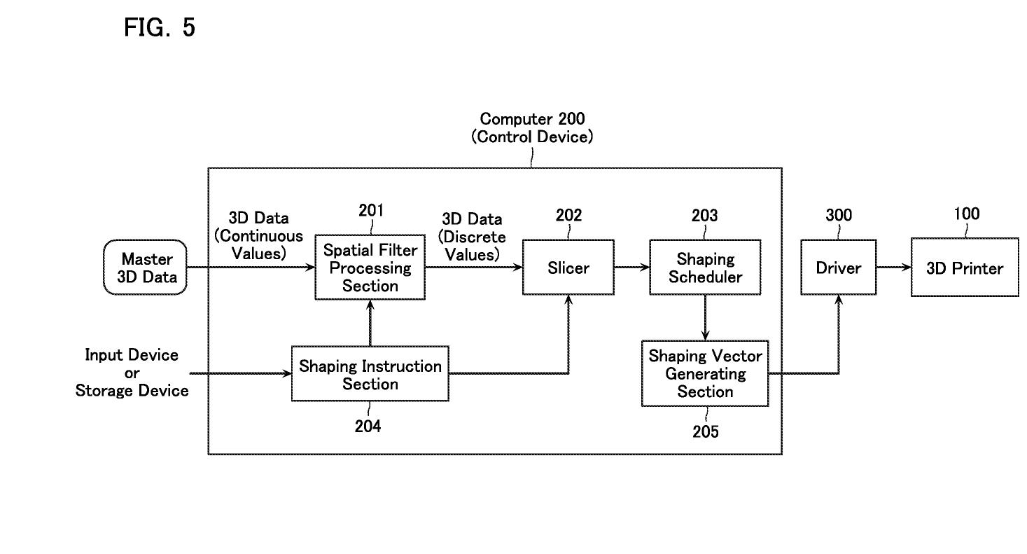

FIG. 5 is a functional block diagram showing a configuration of the computer 200 (control device). The computer 200 includes a spatial filter processing section 201, a slicer 202, a shaping scheduler 203, a shaping instruction section 204, and a shaping vector generating section 205. These configurations can be achieved by a computer program inside the computer 200.

The spatial filter processing section 201 receives, from outside, master 3D data indicating a three-dimensional shape of the shaped object which is to be shaped, and performs various kinds of data processing on a shaping space where the shaped object will be formed based on this master 3D data. Specifically, as will be described later, the spatial filter processing section 201 has a function of dividing the shaping space into a plurality of shaped units Up (x, y, z) as required, and assigning to each of the plurality of shaped units Up property data indicating characteristics that should be given to each of the shaped units, based on the master 3D data. A necessity of division into shaped units and a size of the individual shaped units are determined by a size and shape of the shaped object S to be formed. For example, division into shaped units is not required in a case such as when a mere plate is formed.

The shaping instruction section 204 provides the spatial filter processing section 201 and the slicer 202 with instruction data relating to content of shaping. As an example, the following are included in the instruction data. These are merely an exemplification, and it is possible for all of these instructions to be inputted, or only some to be inputted. Moreover, it goes without saying that an instruction differing from matters listed below may be inputted.

(i) size of one shaped unit Up
(ii) shaping order of the plurality of shaped units Up
(iii) kinds of the plural kinds of resin materials used in the shaped units Up
(iv) combination ratios (combination ratios) of the resin materials of different kinds in the shaped units Up
(v) direction that resin materials of the same kinds are continuously formed in the shaped units Up (hereafter, called “shaping direction”)

Note that the shaping instruction section 204 may receive input of the instruction data from an input device such as a keyboard or mouse, or may be provided with the instruction data from a storage device storing the shaping content.

Moreover, the slicer 202 has a function of converting each of the shaped units Up into a plurality of slice data. The slice data is sent to the later-stage shaping scheduler 203. The shaping scheduler 203 has a role of determining the likes of a shaping procedure or the shaping direction in the slice data, based on the previously mentioned property data. Moreover, the shaping vector generating section 205 generates a shaping vector based on the shaping procedure and shaping direction determined in the shaping scheduler 203. Data of this shaping vector is sent to the driver 300. The driver 300 controls the 3D printer 100 based on the received data of the shaping vector.

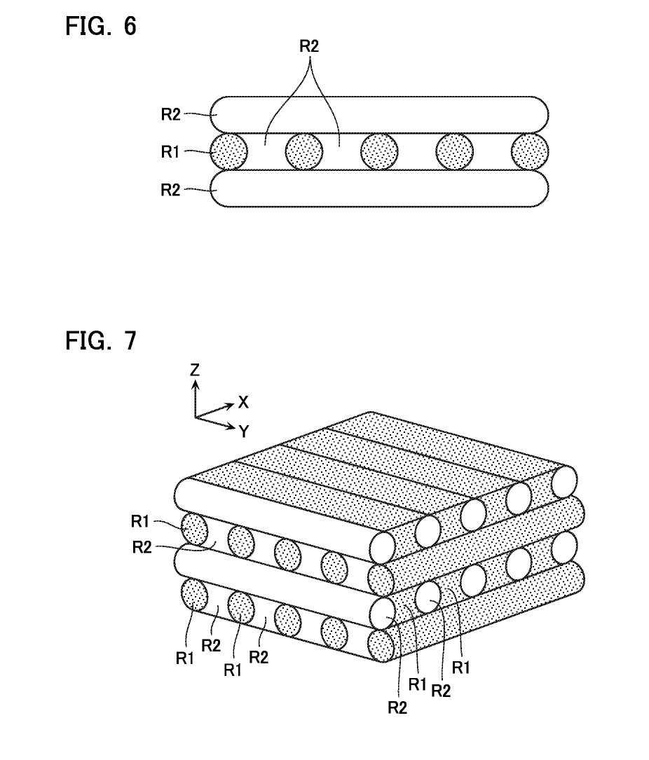

In the three-dimensional shaping apparatus of the present embodiment, the control device 200 operates such that plural kinds of resin materials have a direction that the resin material is extended out (shaping direction) differing for each layer, based on a specified combination ratio of the plurality of resin materials. A structure of the shaped object S formed by the present embodiment is shown as an example in FIGS. 6 and 7.

FIG. 6 is a side view of the shaped object S manufactured by the three-dimensional shaping apparatus of the first embodiment, and FIG. 7 is a perspective view thereof. As shown in FIGS. 6 and 7, in the three-dimensional shaping apparatus of the first embodiment, for example, plural kinds of resin materials R1, R2 are employed to shape one shaped object S (in order to simplify explanation, mainly the case where two kinds of resin materials are used will be described below, but it goes without saying that three or more kinds of resin materials may be employed).

Moreover, in this first embodiment, the plural kinds of resin materials R1, R2 are formed, having one direction as their longitudinal direction, with a certain combination ratio, in one layer. In the example of FIGS. 6 and 7, in a first layer (lowermost layer of FIG. 7), for example, the combination ratio of the resin materials R1, R2 is assumed to be 1:1 and longitudinal directions of each of the resin materials R1, R2 are an X axis direction (first direction), and the resin materials R1 and R2 are formed continuously in the X axis direction, alternately, so as to be arranged along a direction (second direction) orthogonal to the X axis. On the other hand, in a second layer one layer higher than the first layer, the combination ratio of the resin materials R1, R2 is assumed to be 1:1 similarly to in the first layer, but longitudinal directions of each of the resin materials R1, R2 are assumed to be not the X axis direction of the first layer, but an axis (third direction) intersecting this, for example, a Y axis direction, and the resin materials R1, R2 are arranged along the X axis direction (fourth direction). As is clear also from later-mentioned description, the number of resin materials, the combination ratios of the resin materials, and so on, shown in these FIGS. 6 and 7 are merely an example, and may of course be variously changed according to required specifications of the shaped object, and so on. Moreover, there is no need for the structure of FIGS. 6 and 7 to be repeatedly formed in an entirety of the shaped object S. Identical resin materials only may be formed in part of the shaped object S.

In this kind of shaped object S, the resin material R1, while extending in the first direction in one layer, extends in the second direction intersecting the first direction in a layer one higher than that one layer. As a result, the shaped object S has a structure (a so-called parallel cross structure) in which fellow resin materials R1 are joined in an up-down direction at intersection positions of the resin materials R1 in the first layer and the second layer. The resin materials R2 also have a similar parallel cross structure and are joined in the up-down direction similarly at positions sandwiched by the resin materials R1. Due to this kind of structure, even supposing that a joining force (in a transverse direction) between the resin materials R1 and R2 of different kinds is weak, if a joining force (in a laminating direction) between identical resin materials in the above-mentioned kind of parallel cross structure is strong, then strength of the shaped object S can be configured sufficiently high.

Note that although FIGS. 6 and 7 illustrate a structure where the resin materials R1, R2 contact without a gap in one layer, the structure of the shaped object S is not limited to this. A gap may occur between the resin materials adjacent in a transverse direction in one layer.

Moreover, by using the resin materials R1, R2 of different kinds combined in one shaped object S in this way, a shaped object combining characteristics of different kinds of resin materials can be provided. For example, it becomes possible also to have advantages of a first resin material and compensate for disadvantages of the first resin material by advantages of a second resin material.

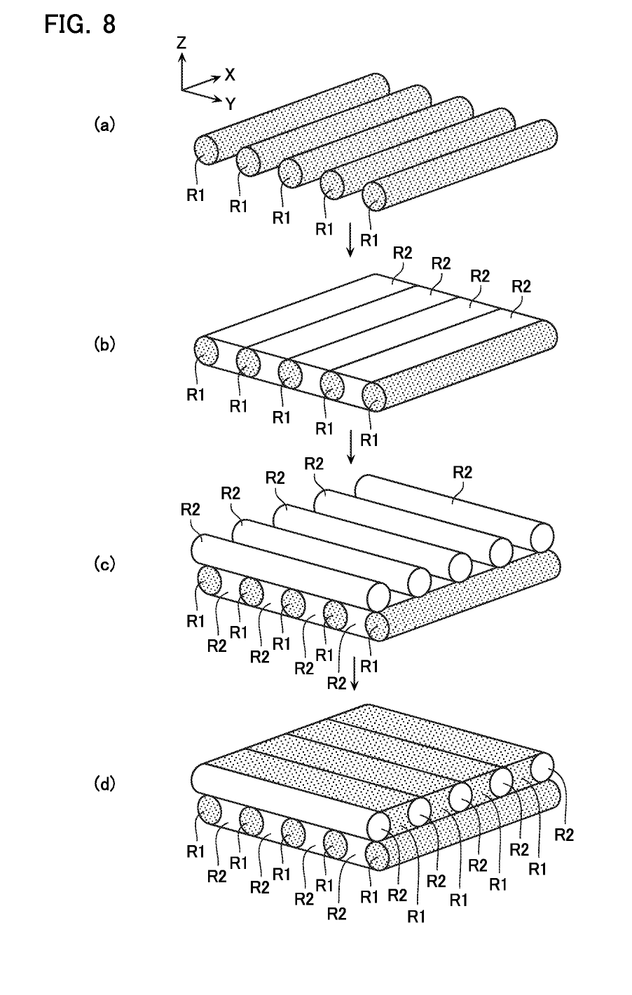

A shaping procedure of the shaped object S shown in FIGS. 6 and 7 will be described with reference to FIG. 8. First, in the first layer, as shown in FIG. 8(a), the resin materials R1 are formed with the X direction as their longitudinal direction, with an arrangement pitch of substantially 1:1.

Then, as shown in FIG. 8(b), the resin materials R2 are similarly formed with an arrangement pitch of substantially 1:1, so as to fill gaps of the resin materials R1. At this time, the resin material R2 can be formed so as to fill the gap of two resin materials R1, along outer peripheral shapes of the resin materials R1. By doing so, joining between the resin materials R1 and R2 can be strengthened.

Next, in the second layer, as shown in FIG. 8(c), the resin materials R2 are formed with the Y direction as their longitudinal direction, with an arrangement pitch of substantially 1:1.

Then, as shown in FIG. 8(d), the resin materials R1 are similarly formed with an arrangement pitch of 1:1, so as to fill gaps of the resin materials R2. At this time, the resin material R1 can be formed so as to fill the gap of two resin materials R2, along outer peripheral shapes of the resin materials R2. By doing so, joining between the resin materials R1 and R2 can be strengthened.

By repeating the above-mentioned procedure shown in FIGS. 8(a) to 8(d), the shaped object S of the above-mentioned parallel cross structure is completed.

Note that in FIGS. 8(c) and 8(d), it is configured such that in the second layer, the resin materials R2 are formed ahead with a certain arrangement pitch, and the resin materials R1 are then filled into gaps of the resin materials R2, and a forming order of the resin materials R1, R2 is made different for the first layer and the second layer. Alternatively, it is possible to configure such that in all of the layers, a specific resin material (for example, the resin material R1) is formed ahead, and another resin material (for example, the resin material R2) is then filled into the gap. However, changing the forming order of the resin materials R1, R2 for each layer enables joining of the resin materials in the up-down direction to be further strengthened, and is more preferable.

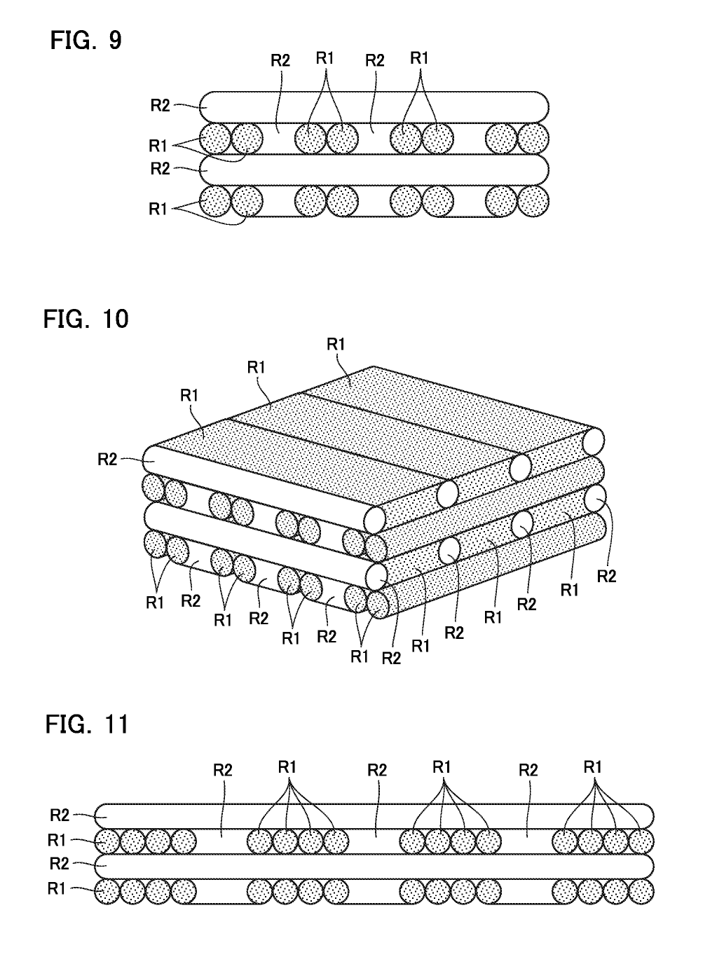

Although FIGS. 6 and 7 illustrated the shaped object S where the combination ratio of the resin materials R1 and R2 was substantially 1:1, it goes without saying that the shaped object S manufactured by the present embodiment is not limited to this. For example, the combination ratio is not limited to 1:1, and another desired ratio may be set. For example, FIGS. 9 and 10 show the case where the combination ratio of the resin materials R1 and R2 is 2:1. Furthermore, it is also possible for the combination ratio to be changed gradually or continuously in the laminating direction and/or a horizontal direction (within an identical layer).

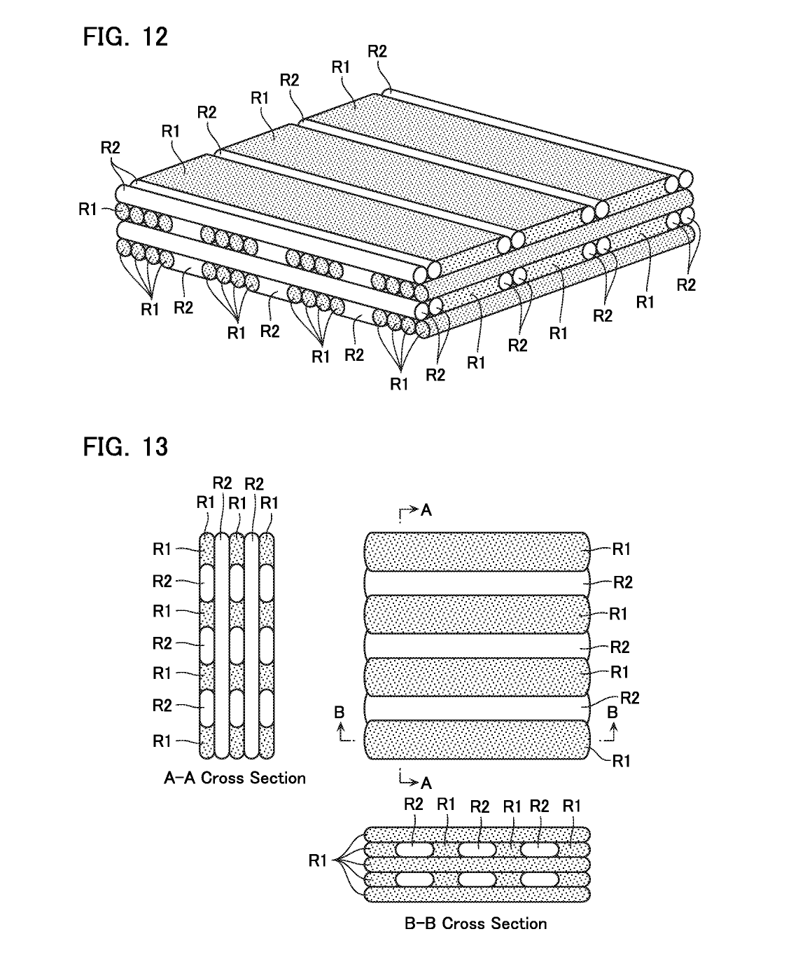

The shaped object S where the combination ratio of the resin materials R1, R2 is 2:1 can be formed by repeatedly forming two resin materials R1 and one resin material R2 as in FIGS. 9 and 10. However, it is not limited to this, and, as shown in FIGS. 11 and 12, for example, the combination ratio 2:1 can be obtained also by repeatedly forming four resin materials R1 and two resin materials R2. A pattern of repetition of the resin materials R1, R2 like in FIG. 9 is expressed as a “2:1 repetition pattern”. Moreover, a case like in FIG. 11 is expressed as a “4:2 repetition pattern”. Moreover, although illustration thereof is omitted, the case where, respectively, m at a time and n at a time of the resin materials R1 and R2 are repeatedly formed is expressed as an m:n repetition pattern. This repetition pattern is expressed by repetition pattern data PR which will be mentioned later.

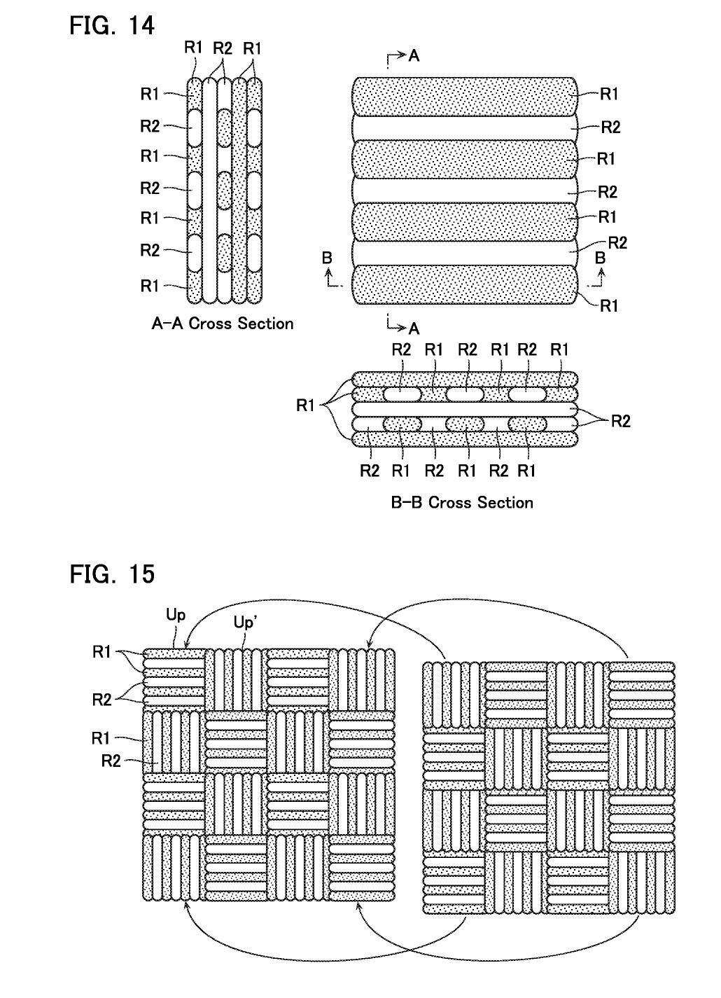

Note that when the same resin material is formed continuously in one layer, although an approximately circular columnar shaped resin material can be continuously formed as in FIGS. 9 and 11, it is also possible for a plate shaped resin material to be formed as shown in FIGS. 13 and 14.

Moreover, in the above-mentioned example, the structure in one shaped unit Up (or, the structure of the shaped object S when division into shaped units is not performed) was described. When the shaped object S is divided into a plurality of shaped units Up, the shaped object S in one layer is configured as in FIG. 15, for example (FIG. 15 is the case where the combination ratio is 1:1, but this is merely an example, and it goes without saying that a combination ratio other than that illustrated may be adopted).

As shown in FIG. 15, the shaping space may be divided into a plurality of shaped units Up as required. One shaped unit Up is further divided into a plurality of slice data, and shaping is performed for each single layer corresponding to the slice data. For example, when shaping of a first layer of one shaped unit Up finishes, next, shaping of a first layer of a shaped unit (for example, the shaped unit Up′ of FIG. 15) adjacent to this shaped unit Up is started.

At this time, in one layer of the shaped unit Up, the resin materials R1, R2 are formed having one direction (for example, the X direction) as their longitudinal direction so as to be adjacent to each other with a certain arrangement pitch, but in the adjacent shaped unit Up′, in the same layer, the resin materials R1, R2 are formed continuously having a different direction (for example, the Y direction) as their longitudinal direction. This is repeated in each layer, whereby the structure like that shown in FIGS. 6 and 7, for example, is formed.

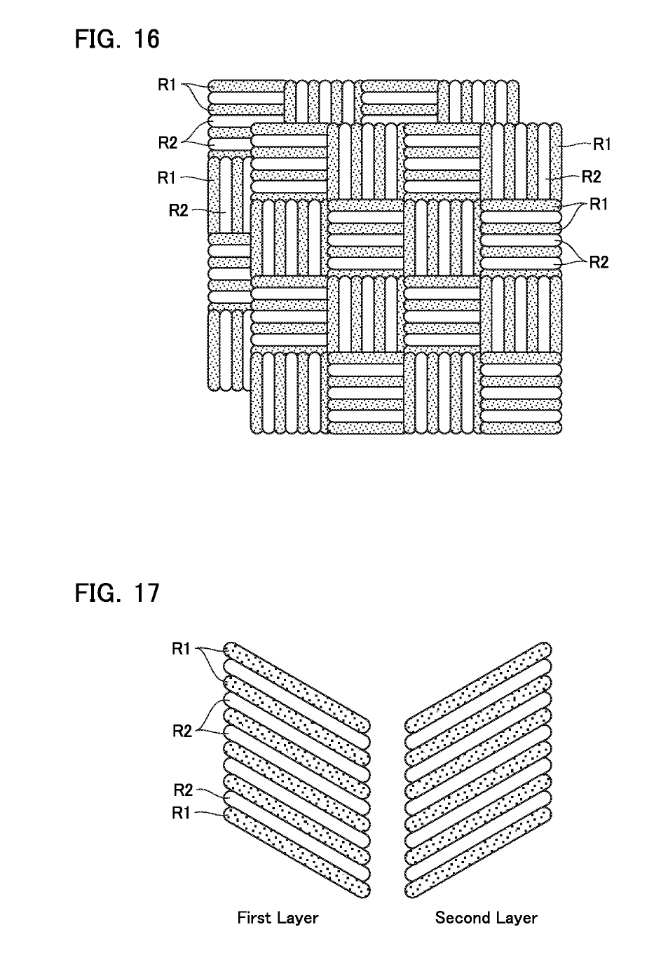

Note that regarding lamination of a plurality of layers, although each of the layers can be laminated parallelly in the Z direction as shown in FIG. 15, there may also be lamination in a form where the layers are misaligned in the XY directions as shown in FIG. 16, for example (FIG. 16 exemplifies the case where there is misalignment by a half pitch at a time in each of the X direction and the Y direction).

FIGS. 17 to 19 show modified examples of the shaped object S.

In the shaped object S of FIGS. 6 and 7, in one layer, the resin materials R1, R2 have a linear shape extending along one direction (the X direction or the Y direction), and in the layer one above that layer, the resin materials R1, R2 have a linear shape extending in a direction orthogonal (with an intersection angle of 90 degrees) to this. However, instead, as shown in FIG. 17, for example, the intersection angle of the resin materials R1, R2 in the upper and lower layers may also be set to an angle other than 90°. In the case of this structure, a joining area between identical resin materials in the upper and lower layers becomes larger compared to in the case of 90°, and strength of the shaped object S can be increased more compared to in the case of FIGS. 6 and 7.

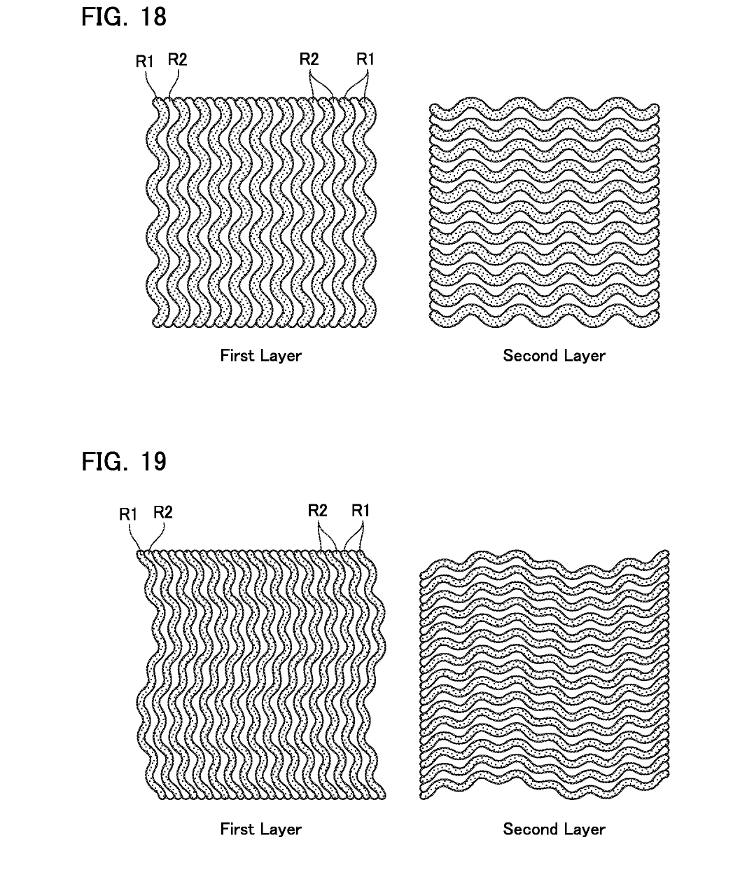

Moreover, in the example of FIGS. 6 and 7, the resin materials R1, R2 in each layer have a linear shape having a certain one direction as their longitudinal direction, but, instead, as shown in FIG. 18, for example, each of the resin materials R1, R2 may have a wavy line shape whose axial direction has one direction as its longitudinal direction (in other words, formed continuously in one direction overall).

Moreover, center lines or envelopes of the wavy line shaped resin materials R1, R2 of FIG. 18 have a linear shape, but, as shown in FIG. 19, those center lines or envelopes themselves may have a wavy line shape. The resin materials R1, R2 of this FIG. 19 are also formed so as to extend having one direction as their longitudinal direction overall. In other words, in the shaped object S of the present embodiment, identical resin materials should be formed so as to intersect each other in the upper and lower layers, and should have a shape by which they are joined at those intersections.

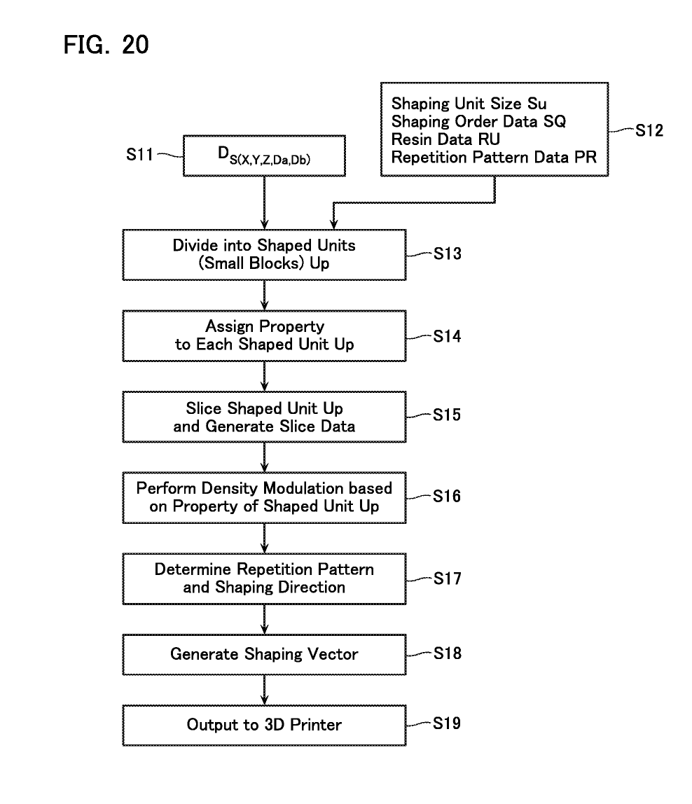

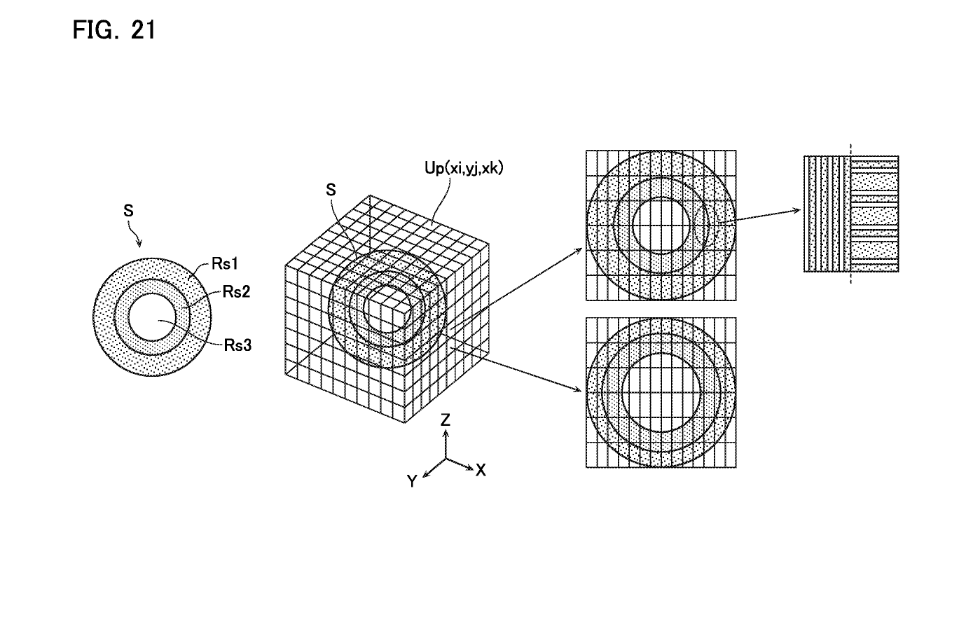

Next, a specific shaping procedure of the shaped object S employing the three-dimensional shaping apparatus of the present embodiment will be described with reference to the flowchart of FIG. 20 and the schematic view of FIG. 21.

First, the computer 200 receives the master 3D data relating to a form of the shaped object S, from outside (S11). Assumed here is a shaped object S of the kind shown on the left side of FIG. 21. The shaped object S illustrated in this FIG. 21 is a triply structured spherical shaped object, and is configured from: an outer peripheral section Rs1 configured mainly from the resin material R1; an inner peripheral section Rs2 in which the resin material R1 and the resin material R2 are mixed; and a central section Rs3 configured mainly from the resin material R2.

The master 3D data includes: coordinates (X, Y, Z) at each configuring point of the shaped object S; and data (Da, Db) indicating the combination ratio of the resin materials R1, R2 at the configuring point. Hereafter, data of each configuring point will be notated as Ds (X, Y, Z, Da, Db). Note that when there are three or more kinds of resin materials used, data Dc, Dd, . . . indicating the combination ratios of the relevant resin materials are added to the configuring point data Ds, in addition to the data Da, Db.

Moreover, the likes of a size Su of a shaped unit Us, shaping order data SQ indicating a procedure for shaping a plurality of the shaped units Us in one layer, resin data RU specifying the plural kinds of resin materials used, and repetition pattern data PR indicating how the plural kinds of resin materials are repeatedly formed (data indicating in what pattern the plural kinds of resin materials are formed), are outputted or instructed from the shaping instruction section 204 (S12). At this time, part or all of necessary data is inputted to the shaping instruction section 204 from outside using an input device such as a keyboard or mouse, or is inputted to the shaping instruction section 204 from an external storage device.

Next, in the spatial filter processing section 201, the shaping space indicated by the master 3D data is divided into a plurality of shaped units Up based on the instructed shaped unit size Su (S13). As shown in FIG. 21, the shaped unit Up is a rectangular shaped space formed by dividing the shaping space of the shaped object S in the XYZ directions.

Each of the divided shaped units Up is assigned with property data reflecting the corresponding configuring point data Ds (X, Y, Z, Da, Db) (S14). Whereas the master 3D data is continuous value 3D data indicating the shape of the shaped object S, data of each of the shaped units Up is discrete value 3D data indicating the shape of each of the shaped units Up.

Next, data of the shaped unit Up assigned with this kind of property data is sent to the slicer 202. The slicer 202 further divides this data of the shaped unit Up along the XY plane, and generates a plurality of sets of slice data (S15). The slice data is assigned with the previously mentioned property data.

Then, the shaping scheduler 203 executes density modulation on each of the slice data, based on the property data included in each of the slice data (S16). Density modulation refers to a calculation operation that determines a forming ratio of the resin materials R1 and R2 in the relevant slice data, based on the previously mentioned combination ratio (Da, Db).

In addition, the shaping scheduler 203 determines the repetition pattern and the shaping direction of the resin materials R1 and R2, based on a calculation result of the previously mentioned density modulation and on the shaping order data SQ and repetition pattern data PR received from the shaping instruction section 204 (S17). In order to obtain the above-mentioned parallel cross structure, the shaping direction in the slice data of one layer is set to a direction orthogonal to that of the slice data in the layer one below that layer.

Then, the shaping vector generating section 205 generates a shaping vector, based on the shaping direction data determined in the shaping scheduler 203 (S18). This shaping vector is outputted to the 3D printer 100 via the driver 300, and a shaping operation based on the master 3D data is executed (S19). Moreover, the plurality of shaped units Up are formed based on the shaping order data SQ instructed by the shaping instruction section 204, and finally, the shaped object S is formed in the entire shaping space.

### Advantages

As described above, due to the three-dimensional shaping apparatus of the present embodiment, shaping heads 24A, 24B are controlled such that in a first layer, plural kinds of resin materials are formed along a first direction, and the plural kinds of resin materials are aligned in a second direction intersecting the first direction. Moreover, the shaping heads 25A, 25B are controlled such that in a second layer provided above the first layer, the plural kinds of resin materials are formed along a third direction intersecting the first direction, and the plurality of kinds of resins are aligned in a fourth direction intersecting the third direction. As a result, in a shaped object, the plural kinds of resin materials are incorporated in a so-called parallel cross structure, and since there exist points where identical materials are in contact in a height direction, then, even when generating a shaped object that complexly employs a plurality of materials, joining between the differing plurality of materials can be comprehensively strengthened.

Moreover, using plural kinds of resin materials in one shaped object makes it possible to provide a shaped object combining advantages of the plural kinds of resin materials. For example, generally, in a material, strength and flexibility have conflicting characteristics, and development and production of a material combining the two is considered to be extremely difficult on a commercial scale. However, due to the shaping apparatus of the present invention, by configuring a parallel cross structure employing, for example, a resin material R1 of high strength and a resin material R2 of high flexibility, it is possible to achieve a resin material of high strength and high flexibility.

Moreover, by making variable a configuring ratio of the resin material R1 and the resin material R2, it is also possible for the strength and flexibility characteristics to be made freely variable.

Moreover, regarding density of a material for which only discrete values could be achieved in conventional technology, a material density of continuous values can be achieved.

Moreover, a mixed material of fellow materials whose specific gravities differ greatly which conventionally could only be achieved in a gravity-free state such as outer space, can also be achieved by this shaping apparatus.

### Second Embodiment

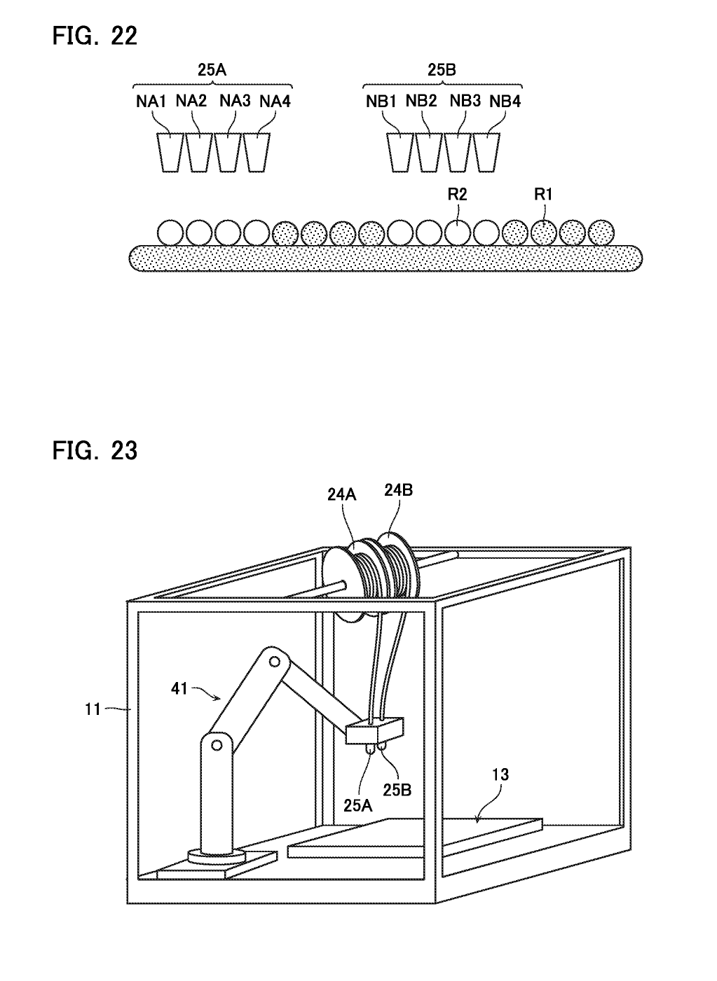

Next, a three-dimensional shaping apparatus according to a second embodiment of the present invention will be described with reference to FIGS. 22 and 23. The three-dimensional shaping apparatus of the second embodiment has an overall configuration and a basic operation and formable shaped object S that are similar to those of the first embodiment, hence duplicated descriptions thereof will be omitted below.

In this second embodiment, the structure of the shaping heads 25A, 25B is different from that of the first embodiment.

The shaping head 25A of this second embodiment includes a plurality of (in the illustrated example, four) discharge holes NA1-NA4 each aligned in a direction orthogonal to the shaping direction. The discharge holes NA1-NA4 are given an arrangement pitch such that the resin materials R1 respectively discharged therefrom are continuously aligned. That is, an opening diameter φ of each of the discharge holes NA1-NA4 and a pitch P between adjacent discharge holes NA1-NA4 determine an arrangement width of the continuously formed resin materials R1.

Similarly, the shaping head 25B also includes a plurality of (in the illustrated example, four) discharge holes NB1-NB4 each aligned in a direction orthogonal to the shaping direction. Note that the discharge holes NA1-NA4, NB1-NB4 are controlled so as to be aligned in a direction orthogonal to a determined shaping direction, based on the shaping direction.

Employing this kind of shaping head makes it possible for shaping efficiency to be improved more compared to in the first embodiment.

[Other]

While certain embodiments have been described, these embodiments have been presented by way of example only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the above-described embodiments, a moving mechanism of the 3D printer 100 includes: the guide shafts 15 extending perpendicularly to the shaping stage 13; the elevator table 14 that moves along the guide shafts 15; and the XY table 12. However, the moving mechanism of the 3D printer 100 of the present invention is not limited to this. For example, it is possible to adopt a moving mechanism in which the XY table 12 where the shaping heads 25A, 25B are mounted is configured fixed, and the shaping stage 13 is configured able to be raised and lowered. In addition, for example, as shown in FIG. 23, the moving mechanism of the 3D printer 100 may include a multi-axis arm 41 having a fixed end on a bottom surface of the frame 11. Moreover, a moving end (elevator section) of this multi-axis arm 41 may be mounted with shaping heads 25A, 25B similar to those of the previously mentioned embodiments.

Moreover, in the above-described embodiments, respectively independent configurations were shown for the 3D printer 100 and the computer 200 and driver 300. However, it is also possible for the computer 200 and the driver 300 to be built in to the 3D printer 100.

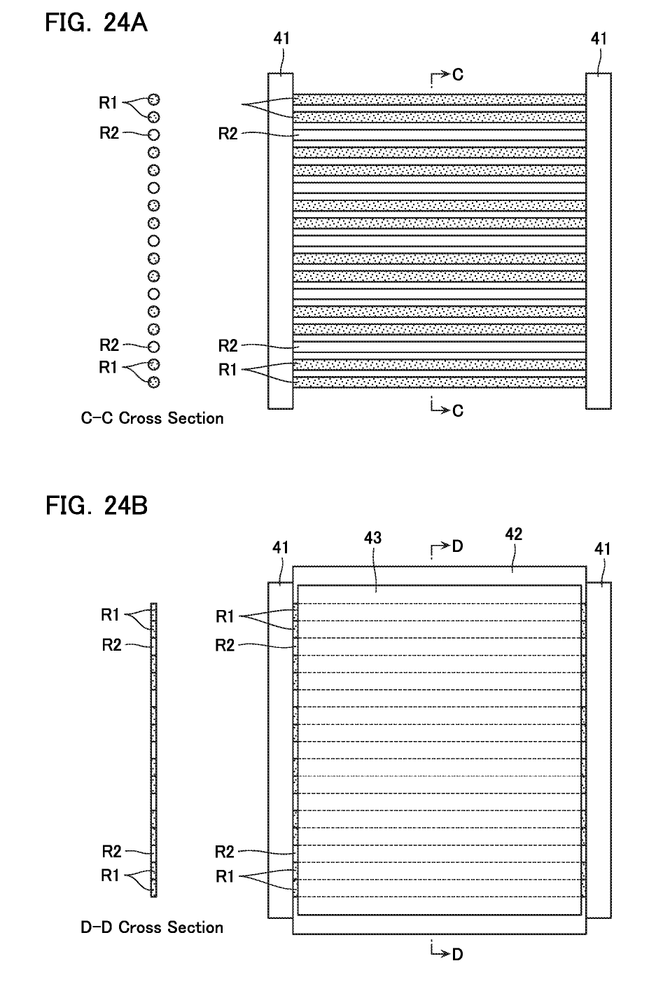

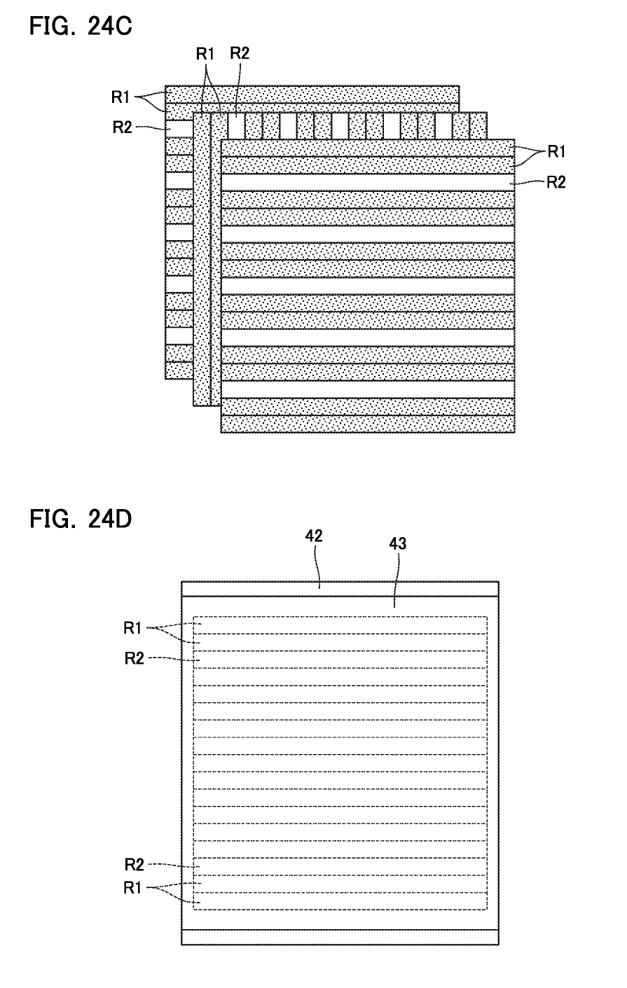

Moreover, the above-mentioned shaped object S is not limited to being manufactured by a three-dimensional shaping apparatus of the kind shown in the first and second embodiments. FIGS. 24A to 24D are process drawings showing other manufacturing steps of the above-mentioned shaped object S. As shown in FIG. 24A, the resin materials R1 and R2 are bunched in parallel to each other, based on a certain arrangement order, and both ends thereof are fixed by fixtures 41. Then, as shown in FIG. 24B, a pressure-applying plate 42 and a heating plate 43 are placed on the resin materials R1 and R2 bunched in parallel to each other, and the resin materials R1 and R2 are heated to a certain temperature while being applied with pressure. As a result, the resin materials R1 and R2 bunched in parallel are rolled in a pressure-applying direction to attain a state of being joined to each other. This step shown in FIG. 24B is repeated a plurality of times, whereby a large number of resin plates in which the resin materials R1 and R2 have been rolled, are formed.

Next, as shown in FIG. 24C, the large number of resin plates configured from the rolled resin materials R1 and R2 are laminated. At this time, the large number of resin plates are disposed such that, in two resin plates adjacent in the up-down direction, longitudinal directions of the resin materials R1 and R2 intersect each other.

Moreover, the pressure-applying plate 42 and the heating plate 43 are again placed on the large number of resin plates that have been laminated in this way, and these laminated resin plates are heated to a certain temperature while being applied with pressure. As a result, a shaped object S similar to that of the above-described embodiments is completed.

Note that it is also possible for the fixtures 41 to be omitted, provided that the resin materials R1 and R2 can be stably held.

Note that in any of the cases of the first embodiment, the second embodiment, and the embodiments of FIGS. 24A to 24D, shaping may be performed while an adhesive agent (adhesive resin) or an adherence agent (surface treatment agent, surface modifying agent, or coupling agent) is being sprayed from outside. Now, an example of the adhesive agent (adhesive resin) is a material functioning to penetrate and fill a gap in an interface of the resin materials R1 and R2. Moreover, an example of the adherence agent (surface treatment agent, surface modifying agent, or coupling agent) is a material functioning to activate surfaces such that a surface of the resin material R1 or R2 or surfaces of both the resin materials R1, R2 have a functional group. By doing so, affinities with each other of the resin materials R1 and R2 increase and the resin materials R1 and R2 are strongly joined, hence even when the resin materials R1 and R2 are resins in a relationship that their affinities with each other are low, the resin materials R1 and R2 can be applied to an application where a breaking strength is required.

[Examples of Shaped Object S]

Various kinds of specific examples (applications) of the shaped object S generated based on the present embodiment will be described below. The shaped object S of the present embodiment may be used in a variety of applications, as will be described below.

### First Specific Example

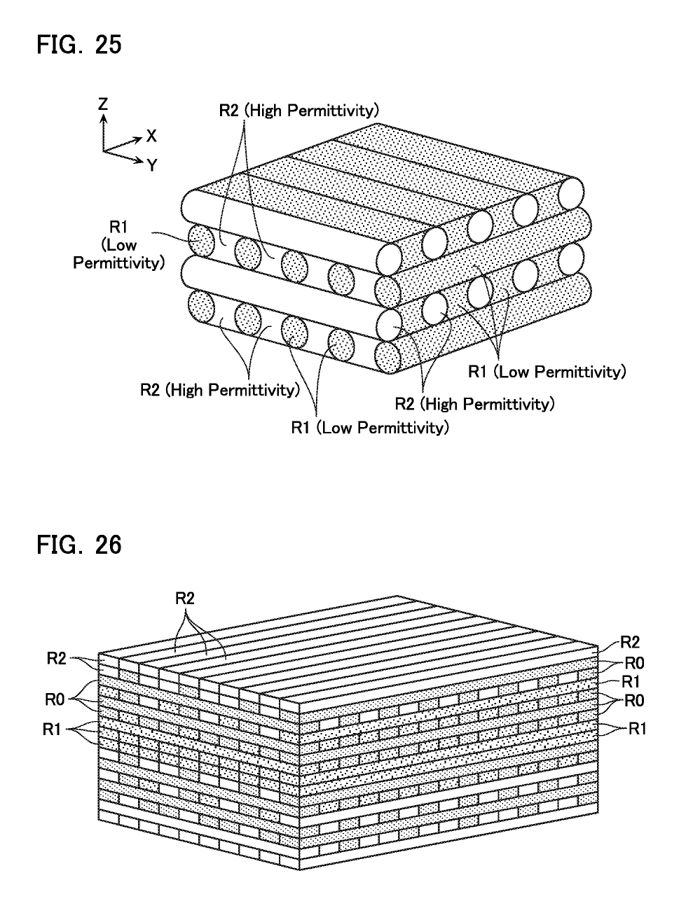

A first specific example of the shaped object S is shown in FIG. 25. In this first specific example, the shaped object S is applied as a material of a printed circuit board for an electronic circuit.

Generally, a glass epoxy resin combining a thermosetting resin and glass fiber is employed in a material of a printed circuit board. However, permittivity of glass fiber, at about 6.13, is extremely large. Therefore, there is a risk that the glass epoxy resin acts as a parasitic capacitance in a circuit mounted with the printed circuit board, that transmission loss or transmission delay increase particularly in a high frequency circuit, and that an error occurs. Note that although it is possible here to lower overall permittivity by mixing of a thermoplastic resin, a printed circuit board is required to have a heat resistance of about 140° C. in actual use, hence a mixing amount of the thermoplastic resin cannot be unconditionally increased.

In the first specific example, by having the following kind of structure, it is possible to provide a printed circuit board having high heat resistance while lowering permittivity. That is, as this first specific example, as shown in FIG. 25, a material of a low dielectric body, for example, polypropylene, polyterafluoroethylene (PTFE), or polychlorotrifluoroethylene (PCTFE) may be employed as the resin material R1. Moreover, a material excelling in heat resistance and rigidity, such as a polycarbonate or liquid crystal polymer, for example, may be employed as a material of the resin material R2. By selecting a combination of such materials and further appropriately setting the combination ratio of the resin materials R1 and R2, it is possible to provide a shaped object of low permittivity and having appropriate heat resistance and rigidity.

As an example, by combining polypropylene and a liquid crystal polymer in a ratio of R1:R2=1:1, it is possible to provide a material whose permittivity is about 2.5 to 2.7. Particularly, when a liquid crystal polymer is employed as the resin material R2, it becomes possible for the printed circuit board to be used in a broadly ranged temperature region, since a thermal expansion coefficient of a liquid crystal polymer is extremely low and its rigidity is high.

Note that materials of the resin materials R1, R2, their combination ratios, and so on, may be arbitrarily selected based on required characteristics of the printed circuit board.

### Second Specific Example

Next, a second specific example of the shaped object S is shown in FIG. 26. In this second specific example, the shaped object S is applied as an electromagnetic wave control element.

This shaped object S of FIG. 26 is configured by combining the resin materials R1 and R2, in addition to a main frame material R0 acting as a framework of the shaped object S. The main frame material R0 has a so-called parallel cross structure. That is, as shown in FIG. 26, a longitudinal direction of the main frame materials R0 in a first layer and a longitudinal direction of the main frame materials R0 in a second layer directly above the first layer intersect, and fellow main frame materials R0 are joined in the up-down direction at their intersection positions. On the other hand, the resin materials R1, R2 are formed so as to fill gaps of the main frame materials R0 of this parallel cross structure. By the main frame material R0 having a parallel cross structure in this way, it is made possible to provide an electromagnetic wave control element in which strength of the shaped object S overall is raised and that has desired characteristics due to the resin materials R1, R2 filled into gaps thereof.

A polycarbonate resin, for example, may be used as a material of the main frame material R0. Note that there is no need for the parallel cross structure of the main frame R0 to be formed over an entirety of the shaped object S, and that it is also possible to configure a shaped object S where partially the parallel cross structure does not exist as in FIG. 26.

Similarly to in the first specific example, a low dielectric body material such as polypropylene, polyterafluoroethylene (PTFE), or polychlorotrifluoroethylene (PCTFE) may be employed as the resin material R1. Moreover, a high dielectric body material such as polyvinylidene fluoride (PVDF) may be employed as the resin material R2.

By laminating the resin materials R1, R2 alternately at certain intervals on the inside of the shaped object S and appropriately adjusting their combination ratios and arrangement pitches, it is possible to change electromagnetic wave attenuation characteristics possessed by the shaped object S. Specifically, since electric field-related refraction, reflection, and penetration change as the combination ratio or arrangement pitch changes for each layer or in-plane, a change in transmission length or change in vector direction of a polarization plane occurs, and attenuation characteristics of an electromagnetic wave can be adjusted. For example, by the arrangement pitch of the resin materials R1 and R2 changing, a degree of refraction or reflection with respect to the electric field at their interface changes, the transmission length changes, and an attenuation amount changes. Moreover, by the arrangement pitch in the laminating direction of the resin materials R1 and R2 changing, a phase of the electric field of a reflecting electromagnetic wave changes, whereby part of the electromagnetic wave is negated or weakened. Furthermore, by the combination ratio, and so on, of the resin materials R1 and R2 changing, a proportion of the electromagnetic wave changing to heat by negation due to phase change or a complex transmission path, also changes. Moreover, changing the combination ratio, and so on, of the resin materials R1 and R2 makes it possible to handle also a change in the electric field vector of the polarization plane of the electromagnetic wave, and to control the attenuation amount.

In this way, this second specific example makes it possible to provide an electromagnetic wave control element capable of controlling handling of attenuation characteristics of any electromagnetic wave regardless of polarization method or frequency, to a combination of the likes of refraction, reflection, or penetration of an electric field or a polarization plane. For example, it is possible to provide an electromagnetic wave absorbing body in any frequency (or any frequency band). Particularly, by three different permittivity materials being configured to change across multi-layers while having multiple kinds of in-plane configurations as in FIG. 26, negation due to reflection or attenuation due to extension of transmission length occurs in a plurality of modes, inside the shaped object S. As a result of this, the electromagnetic wave control element can function as an electromagnetic wave absorbing body not only in the case of a linearly polarized (vertically or horizontally polarized) electromagnetic wave, but even in the case of a circularly polarized or elliptically polarized electromagnetic wave.

Note that in this second specific example, it is also possible to omit the main frame material R0 and form the shaped object S (electromagnetic wave control element) by the resin materials R1 and R2 only.

### Third Specific Example

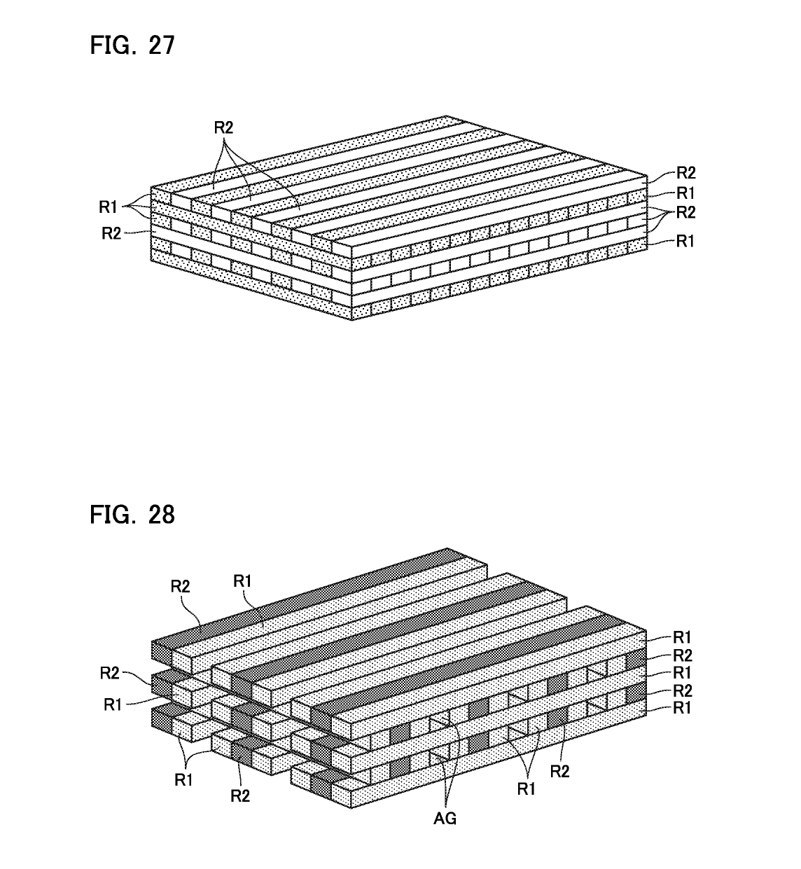

Next, a third specific example of the shaped object S is shown in FIG. 27. In this third specific example, the shaped object S is applied to a material of a sound wave absorbing element.

This shaped object of FIG. 26 may also be similarly formed by laminating the resin materials R1 and R2 in a parallel cross structure. Note that, similarly to in the second specific example, it is also possible to add the main frame material R0 that will be a framework of the shaped object S, in addition to the resin materials R1 and R2.

When forming a sound wave absorbing element by the shaped object S, it is possible to employ a material whose rigidity is high but whose flexibility is poor and a material whose rigidity is low but whose flexibility is high, as the combination of resin materials R1, R2. As a result, a speed of sound waves changes at a boundary of the resin materials R1 and R2, whereby sound waves are mutually cancelled out by a phase difference arising between the sound waves, and the sound waves are absorbed. As an example, a polycarbonate resin whose rigidity is high can be employed as the resin material R1, and a material whose flexibility is high such as an elastomer can be employed as the resin material R2. By adopting such a configuration, audible range sound waves or ultrasonic waves can be attenuated and suppressed, and, in effect, an element blocking these waves can be made. Moreover, by changing the pitch between layers, it is also possible to change a frequency being suppressed (or a frequency band being suppressed). Note that when the present sound wave absorbing element is applied to an enclosure of a canal type earphone (inner ear headphone), sound leakage can be prevented by absorption of sound waves to the outside while audible range sound waves are transmitted unhindered to inside of the ear.

### Fourth Specific Example

Next, a fourth specific example of the shaped object S is shown in FIG. 28. In this fourth specific example, the shaped object S is applied to a material of an impact absorbing element. Conventionally, a foamed material whose flexibility is high or a gelled material has often been used as an impact absorbing element. However, the foamed material or gelled material has a problem that permeability is poor. The shaped object S of this fourth specific example makes it possible to provide an impact absorbing element solving the above-described problem of permeability, by having the following features.

This shaped object S of the fourth specific example of FIG. 28 may also be similarly formed by laminating the resin materials R1 and R2 in a parallel cross structure. Note that, similarly to in the second specific example, it is also possible to add the main frame material R0 that will be a framework of the shaped object S, in addition to the resin materials R1 and R2.

When forming an impact absorbing element by the shaped object S, it is possible to employ a material whose rigidity is high and a material whose rigidity is low but whose flexibility is high, as the combination of resin materials R1, R2. As an example, a polycarbonate resin whose rigidity is high can be employed as the resin material R1, and a material whose flexibility is high such as an elastomer can be employed, acting as an elastic reinforcing material, as the resin material R2. Furthermore, in this fourth specific example, gaps in the parallel cross structure of the resin materials R1 are not completely filled by the resin materials R2, and in parts, cavities AG are left. Such cavities AG can be formed with a desired density and arrangement pitch by adopting the manufacturing steps of the kind described by FIG. 8, for example. The fourth specific example configured in this way makes it possible to provide a shaped object S achieving coexistence of impact absorbing qualities and permeability.

### DESCRIPTION OF REFERENCE NUMERALS

100 3D printer
200 computer
300 driver
11 frame
12 XY stage
13 shaping stage
14 elevator table
15 guide shaft
21 frame body
22 X guide rail
23 Y guide rail
24A, 24B filament holder
25A, 25B shaping head
31 frame body
34, 35 roller
38A, 38B filament
201 spatial filter processing section
202 slicer
203 shaping scheduler
204 shaping instruction section
205 shaping vector generating section

1. A three-dimensional shaping apparatus, comprising:
a shaping stage on which a shaped object is placed;
an elevator section which is movable in at least a perpendicular direction with respect to the shaping stage;
a shaping head which is mounted in the elevator section and receives supply of plural kinds of resin materials whose materials differ; and
a control section that controls the elevator section and the shaping head, wherein
the control section controls the shaping head such that, in a first layer, first resin materials are continuously formed in a first direction and arranged with a gap between the first resin materials in a second direction intersecting the first direction, and second resin materials other than the first resin materials are continuously formed in the first direction and arranged in the gap, the first resin materials being one of the plural kinds of resin materials, and the second resin material being one of the plural kinds of resin materials, and
the control section further controls the shaping head such that, in a second layer provided above the first layer, the first resin materials are continuously formed in a third direction intersecting the first direction and arranged with a gap between the first resin materials in a fourth direction intersecting the third direction, and the second resin materials are continuously formed in the third direction and arranged in the gap, whereby the first resin materials formed in the first layer and the first resin materials formed in the second layer are joined in an up-down direction, and, furthermore, the second resin materials formed in the first layer and the second resin materials formed in the second layer are joined in the up-down direction.

2. The three-dimensional shaping apparatus described in claim 1, wherein
the control section
receives shaped object data including coordinate data and combination ratio data that expresses a combination ratio of the plural kinds of resin materials at a position indicated by the coordinate data, and
controls the shaping head based on this shaped object data.

3. The three-dimensional shaping apparatus described in claim 2, wherein
the control section divides into a plurality of shaped units a region where the shaped object is formed,
assigns to each of the plurality of shaped units property data corresponding to the corresponding shaped object data, and
determines density modulation and shaping direction of each of the plurality of kinds in each of the shaped units, based on the property data.

4. The three-dimensional shaping apparatus described in claim 1, wherein
the control section controls the shaping head such that, in the first layer, the second resin materials are formed after the first resin materials have been formed, and, in the second layer, the first resin materials are formed after the second resin materials have been formed.

5. A shaped object that includes plural kinds of resin materials, the shaped object including a first layer and a second layer,
the shaped object being wherein
the first layer includes a portion where first resin materials are continuously formed in a first direction and arranged with a gap between the first resin materials in a second direction intersecting the first direction, and second resin materials other than the first resin materials are continuously formed in the first direction and arranged in the gap, the first resin materials being one of the plural kinds of resin materials, and the second resin materials being one of the plural kinds of resin materials and
the second layer provided above the first layer includes a portion where the first resin materials are continuously formed in a third direction intersecting the first direction and arranged with a gap between the first resin materials in a fourth direction intersecting the third direction, and the second resin materials of the plural kinds of resin materials are continuously formed in the third direction and arranged in the gap, whereby the first resin materials formed in the first layer and the first resin materials formed in the second layer are joined in an up-down direction, and, furthermore, the second resin materials formed in the first layer and the second resin materials formed in the second layer are joined in the up-down direction.

6. The shaped object described in claim 5, wherein
each of the first layer and the second layer is divided into a plurality of units, and in the plurality of units adjacent to each other, directions in which the first resin materials and the second resin materials are continuously formed differ from each other.

7. The shaped object described in claim 5, wherein
the first resin materials and the second resin materials have different permittivities.

8. The shaped object described in claim 5, wherein
the resin materials and the second resin materials have different rigidities.

9. The shaped object described in claim 5, comprising
the gap that has been left without being filled by the second resin materials.

10. A method of controlling a three-dimensional shaping apparatus, the three-dimensional shaping apparatus comprising a shaping head,
the method being characterized by comprising the steps of:
controlling the shaping head such that, in a first layer, first resin materials are continuously formed in a first direction and arranged with a gap between the first resin materials in a second direction intersecting the first direction, and resin materials other than the first resin materials are continuously formed in the first direction and arranged in the gap; the first resin materials being one of the plural kinds of resin materials, and the resin material being one of the plural kinds of resin materials and
controlling the shaping head such that, in a second layer provided above the first layer, the first resin materials are continuously formed in a third direction intersecting the first direction and arranged with a gap between the first resin materials in a fourth direction intersecting the third direction, and the resin materials other than the first resin materials are continuously formed in the third direction and arranged in the gap, whereby the first resin materials formed in the first layer and the first resin materials formed in the second layer are joined in an up-down direction, and, furthermore, the resin materials other than the first resin materials formed in the first layer and the resin materials other than the first resin materials formed in the second layer are joined in the up-down direction.

11. The method of controlling described in claim 10, wherein
shaped object data including coordinate data and combination ratio data that expresses a combination ratio of the plural kinds of resin materials at a position indicated by the coordinate data, is received, and the shaping head is controlled based on this shaped object data.

12. The method of controlling described in claim 11, characterized by further comprising the steps of:
dividing into a plurality of shaped units a region where the shaped object is formed;
assigning to each of the plurality of shaped units property data corresponding to the corresponding shaped object data; and
determining density modulation and shaping direction of each of the plurality of kinds in each of the shaped units, based on the property data.
